(19) United States
(12) Patent Application Publication
(10) Pub. No.: US 2018/0222262 A1
(43) Pub. Date: Aug. 9, 2018

(54) Horizontal Pull-Force Optimized and Lateral Sway Minimized Integrally-Formed Towing and/or Winching Apparatus

(71) Applicant: Jimmie D. Vetkos, Grants Pass, OR (US)

(72) Inventor: Jimmie D. Vetkos, Grants Pass, OR (US)

(73) Assignee: Jimmie D. Vetkos, Grants Pass, OR (US)

(21) Appl. No.: 15/428,118

(22) Filed: Feb. 8, 2017

(51) Int. Cl. B60D 1/18; B60D 1/06; B60D 1/28; B66D 1/28

(52) U.S. Cl. CPC B60D 1/185; B60D 1/06; B66D 2700/0183; B66D 1/28; B60D 1/28

(57) ABSTRACT

The present invention relates to an integrally formed apparatus selectively operable for winching and/or towing operations mountable to and removable from a vehicle end-mounted trailer hitch receiver. The integrally formed apparatus comprises a low-profile hitch ball mounting distal portion, a low-profile winch mounting central portion, and a trailer hitch receiver insertable portion. The low-profile ball mount and winch mount adjoin the apparatus with a vertically-spaced interval provided therebetween, wherein no portion of a fastened hitch ball, or coupler lock-mechanism above the ball, impedes or obstructs a tensioning or pull-force exerted on a winch cable extending outwardly principally in alignment with a horizontal axis, or in close parallel alignment with a bed of a trailer coupled to the hitch ball. The low-profile winch mount further provides a minimized vertical moment-arm, and clearance above a mounted winch allowing for up to a full range of hinge-pivoting door(s), lift-gate or tailgate movements.

### CROSS REFERENCE TO RELATED APPLICATIONS

This application claims priority to Provisional U.S. Patent Application No. 62/292,688, filed on Feb. 8, 2016, and is a continuation-in-part application of U.S. patent application Ser. No. 15/015,032, filed Feb. 3, 2016, which claims benefit of Provisional U.S. Application No. 62/112,064, filed Feb. 4, 2015, all of which are incorporated herein by reference in their entireties.

### FIELD OF THE INVENTION

The present invention relates to the field of winches of lower and higher pull-force ranges mounted or mountable on apparatus releasably securable to a trailer hitch receiver such that a mounted winch is proximate an end of a vehicle such as a truck, search-and-rescue vehicle, automobile or van, ATV, boat, or the like. More particularly, the invention relates to integrally formed ones of such apparatus operable, when securely engaged by a vehicle mounted trailer hitch receiver, for either or both of: (i.) a towing of a trailer within a range of common slower trailer-maneuvering speeds to common street or highway traveling speeds, (ii.) winching operations including those optimized for lower and higher pull-force horizontal cable operations and/or a tensioning of a horizontal outwardly extending portion of an engaged winch cable, wherein the winch cable is unimpeded by a height of a mounted trailer hitch ball, or a coupler locking mechanism securing a trailer coupler to a mounted trailer hitch ball.

### BACKGROUND OF THE INVENTION

While several attempts have been made to provide a vehicle-end winch mounting apparatus which is insertable into and releasably fastenable within a trailer hitch receiver tube of a trailer hitch receiver and compatible with varied vehicles, including apparatus also incorporating a mounted or releasably attachable trailer hitch ball mount, such attempts have not been optimal for winches of a type providing both lower and higher ranges of winch pull-forces. For example, in the status quo, a substantial majority of vehicle mounted higher pull-force winches do not also include a low-profile trailer hitch ball mount and thus are not equipped to provide the advantages of an apparatus which can simultaneously or separately employ winch and trailer pulling functions.

Moreover, the status quo approaches have not included apparatus that have been optimal for such combined winching and towing operations. For example, wherein an apparatus has one or more portions extending exteriorly out from a receptacle of a trailer hitch receiver (i.e., when the apparatus is mounted for either or both operations), which are separably segmented, or separably jointed and/or pinned, and thereby subject to an increased or compounded lateral-swaying and/or fishtailing, during one or more towing operations. For example, one or more of the status quo approaches have provided separably-joinable apparatus portions, exterior to a receptacle of a trailer hitch receiver, e.g., separable following a releasing of a transverse keeper pin, wherein: a single transverse pin holding together a plurality of separable external parts allows a first degree of play and/or pivoting to occur between its respectively pinned parts; and wherein, a plurality of transverse pins each holding together a respective different plurality of separable external parts allows an increased or compounded degree of play and/or pivoting to occur between all respectively pinned parts. The compounded degree of play and/or pivoting attributable to removable jointed segments exterior to the trailer hitch receiver, can also occur vertically and/or laterally e.g., wherein the upper mounted winch encounters forward-and-aft and/or side-to-side oscillations.

For example, in one of the status quo approaches, jointed segments of an apparatus, each exterior to a respective trailer hitch receiver, are pinned together in a principally T-shaped' arrangement, wherein a heaviest component of the apparatus, a winch mounted atop a pinned vertical elongate member. The vertical elongate member (having a 1^{st} degree of play and/or pivot) is, in turn mounted on a pinned horizontal elongate member (having a 2^{nd} degree of play and/or pivot), which in turn is pinned to a trailer hitch receiver (having a 3^{rd} degree of play and/or pivot). Thus configured, the apparatus is susceptible to a compounding of each of the degrees of play and/or pivot, for example, compounded as a vehicle is traveling at highway speeds bounding down the road bumping up and down and/or veering right to left as needed. Thus, a first lateral movement imparted to one or more separable horizontal pinned members, e.g., by a turning of a vehicle and/or respective trailer can translate that lateral movement to a vertical pinned member and onto the winch itself. As the winch mounted atop the vertical pinned member, would have the most play and/or pivoting (being the last in a multi-pinned/pivot chain), the winch itself can develop a type of inverted pendulum effect or reciprocating hammer like action (side-to-side and/or forward/aft), which in turn, can induce, then compound, a lateral swaying at the rear of the vehicle, if not result in a fishtailing of respective trailer and/or vehicle.

It is also noted that each single-pinning of a first elongate member to a second one, exterior to a respective trailer hitch receiver, means that X/Y/Z load forces imposed on the exterior pinned portions of the apparatus, during towing and/or winch operations, are no longer borne fundamentally by the elongate members themselves, but rather, by each pin and the single-wall drilled or formed apertures through which each single-pin extends.

Another problem encountered in the status quo approaches is attributable to a disadvantageous height placement of a trailer ball mount relative to a mounted winch, wherein the height of a mounted trailer ball is such that it, or a coupler latch or screw handle thereabove (used to secure a trailer coupler onto the hitch ball), is directly in the path of a winch cable when extending outwardly in a horizontal axis from a lower side of a winch drum. In such approaches, the height of a proximate mounted trailer hitch ball and/or coupler locking mechanism thereabove, is avoided by a winch cable being angled upwardly and away from a respective trailer frame or bed, for example, such that an engaging distal end of the winch cable is attached to an upper portion of a bow of a boat loaded on the trailer. Such a ‘hitch ball-high’/‘winch cable-low’ arrangement means, in a dual-use mode, wherein both a winching and towing operation occurs, a respective winch cable will be obstructed, significantly impeded or rendered unusable, for horizontal or principally horizontal winch cable operations, which in turn means, the higher pull-forces of which a respective winch is capable and/or that which a respective trailer hitch receiver can provide, are also significantly reduced or eliminated in dual-use modes of operation.

More particularly, efforts made with such dual-function apparatus have had an “L” or “J” shaped side-profile wherein the outer/upper winch mounts are configured at a height significantly higher than a respective trailer receiver tube within which, a lower vehicle-facing end of the apparatus is releasably fastened. As such an upwardly extending support member of such winch mounts is increased in height, a corresponding increase in a vertical moment arm is created. The vertical moment arm in turn results in a lever effect wherein a generally-horizontal pull-force, applied to an extended cable portion of a winch cable of a winch, pulls outwardly on a winch mount at an upper end of the upwardly extending support member, which in turn translates a good deal of the outward pull force into a downward force borne by a vehicle's trailer receiver and its respective connecting points and/or seams attaching the receiver to a vehicle. This levering effect translating a major portion of an outward force into a downward one can be seen in ‘Prior Art’ FIGS. 1 and 2, annotated and referenced herein as FIGS. 3A and 3B respectively. Wherein, in FIG. 3A a generally “J” shaped apparatus profile comprises a horizontal member 14 supporting a vertical member 16, wherein a vertical moment arm “100” converts a good deal of any outward pull-force “A” into a corresponding downward force “B” which is initially applied to a trailer hitch receiver tube at “C” (in effect a fulcrum point) which in turn is applied as a downward force to the entire vehicle receiver and any mounting means thereof. The same “A”, “B” and “C” forces can be seen in a depiction of a generally “L” shaped apparatus profile in FIG. 3B.

Accordingly, where winches are of a type providing higher ranges of winch pull-forces e.g., in a range of winches having 8,000-12,000 pound pull-force capacities, it would be advantageous to provide a trailer hitch and winch incorporating apparatus wherein the winch mount has a significantly reduced or minimized vertical moment arm, so as to significantly reduce or minimize unneeded downward forces, and wherein generally horizontal winch cable pull-forces occur principally in alignment with vehicle trailer receiver mounting means not having to also bear, or needing to be modified or bolstered to bear, unneeded and substantial downward forces. As the dual-function winch/trailer hitch apparatus status quo approaches have not addressed such vertical moment arm related problems it is among the objects or the present invention to do so.

In a co-pending application filed by the applicant of the present invention, the Prior Art reference mentioned above (U.S. patent application Ser. No. 10/653,810 by Thompson) is referenced by the applicant concerning winch-to-vehicle proximity related issues, wherein the present applicant pointed out how a Thompson substantially vertical elongate winch support member (16) when supporting a winch mounted on a winch mount thereabove, due to the supported height of the winch and its proximity to a vehicle-end or end-profile of a vehicle, obstruct or significantly impede the pivotal movement of a hinged tailgate, or one or more doors proximate thereto. Whereas, in the present invention, a winch is mountable atop a winch mount having a significantly reduced or minimized vertical moment arm, which in many cases is sufficient in its reduced or minimized mounted winch height to avoid or substantially reduce such obstructing or impeding of a proximate hinged tailgate, or one or more vehicle doors.

Additionally, Thompson employs a relatively short first horizontal member which is single-pinned to a typical vehicle-end trailer hitch receiver, then a larger second horizontal member is single-pinned to the first horizontal member, then a trailer hitch ball mount is single-pinned to the second horizontal member, such that, there are three single-pinned joints before a trailer is even hitched to the apparatus. It is well-known that trailers and other towed apparatus can be subject to fish-tailing even when only a ball mount is mounted directly onto a vehicle-end, let alone when three interfitting parts are also pinned to one another and subject thereby to increased side-to-side lateral sway. Thompson further compounds a likelihood of imparting or increasing unwanted and/or unsafe side-to-side oscillations by the mounting of a relatively heavy winch at the highest point of his triple single-pinned apparatus. Accordingly, an initial half fish-tail motion in a first lateral direction can cause a corresponding lateral leaning or swinging of the triple single-pinned winch in the same direction, and a counter full fish-tail motion cause an even greater leaning and/or swinging in an opposite direction, such that the relatively heavy weight of the winch thereafter adds an increased momentum to each fish-tail motion. It is noted, that if the winch has to be removed before moving a vehicle with an attached trailer from one location to another to reduce such fish-tailing, that the ball mount is still left ‘double-jointed’ with a double single-pin-per-member configuration, which can also compound fish-tailing or oscillations even when no winch is installed. A related problem to the Thompson triple single-pinned horizontal arrangement of components is, that any increase in their collective length will likely cause more play, which in turn, becomes a potential fish-tailing or oscillation multiplier.

An additional problem relating to Thompson FIGS. 1 and 2 (included herein in FIGS. 3A and 3B respectively), is Thompson's “vertical tube” (or “substantially perpendicular” one) and a separate winch-plate mounting component extending upwardly therefrom, causing an abrupt in the height change in the Thompson apparatus particularly when adding the height, length and width of the winch atop the winch mounting plate. Such an arrangement renders a Thompson apparatus unemployable on numerous vehicles equipped with a recessed trailer hitch receiver and receiver tube, and/or recessed and having a vehicle-end profile thereabove unable to accommodate the abrupt height-change in the vertically-aligned components. It is noted that such recessed receivers and vehicle-end profiles are not limited to merely common on-road vehicles such as trucks and vans, but are also commonly encountered with off-road vehicles such ATVs, search-and-rescue, and other recreational vehicles.

Other status quo attempts were made to adapt various types of frameworks to a horizontal member insertable into a trailer hitch receiver and equipped with an elongate vertical member, but did so in a manner such that the vertical member was closely proximate a vehicle-end hinged member (e.g., tailgate of a pickup truck).

Accordingly it would be advantageous to provide an apparatus configured removably securable within a trailer hitch receiver, or trailer hitch-like receiver, which is configured having an reduced or minimized vertical moment arm winch mount, located proximate or adjacently atop of the apparatus horizontal member, wherein the elongate horizontal member is integrally formed lengthwise and its constituent components integrally formed or welded together to minimize or eliminate wobbling or play attributable to status quo interfitted-parts, and it is among the objects of the present invention to provide such improvements.

It would also be advantageous to provide a removably fastenable apparatus for trailer hitch receivers, or trailer hitch-like receivers, which is configured having an integrally formed elongate horizontal member which supports an integrally formed reduced or minimized height winch mounting plate, to provide improved clearance proximate or under vehicle-end profiles so as to be compatible with a significantly broader range of varied vehicle types, including those with one or more vehicle-end hinged members, and it is among the objects of the present invention to provide such improvements.

Other objects will be apparent to one skilled in the art and still other objects will become apparent hereinafter.

### SUMMARY OF THE INVENTION

The present invention relates to integrally formed elongate, low-profile hitch ball and winch mounting apparatuses operable, when securely engaged by a vehicle mounted trailer hitch receiver, for either or both of: (i.) a towing of a trailer within a range of common slower trailer-maneuvering speeds to common street or highway traveling speeds, (ii.) winching operations including those optimized for lower and higher pull-force horizontal cable operations and/or a tensioning of a horizontal outwardly extending portion of an engaged winch cable, wherein the winch cable is unimpeded by a height of a mounted trailer hitch ball, or a coupler locking mechanism securing a trailer coupler to a mounted trailer hitch ball.

The term “integrally formed” as used herein is intended to include an end-to-end arrangement of an elongate, low-profile hitch ball and low-profile winch mounting apparatus, wherein in preferred embodiments, the apparatus comprises a first, low-profile hitch ball mounting distal portion, a second, low-profile winch mounting central portion, and a third, trailer hitch receiver insertable portion, wherein the three portions are arranged such that they are contiguously molded, forged, formed, adjoined and/or welded to one another in series, and such that no portion other than the trailer hitch receiver insertable portion is made pinnable and having transverse aligned apertures (so as to be separable). In other words, wherein neither the first or second portions, exterior to the third portion when the apparatus is operatively mounted, are pinned and/or made separably segmented or jointed. Alternatively, or additionally, a normally exterior portion such as the second, low-profile winch mounting central portion, and/or riser portion thereabove, may be fitted on, or have welded onto, one or more sides, a reinforcing gusset e.g., to enhance pull-forces that can be exerted by a respective mounted winch and/or trailer hitch ball, and borne by the apparatus(es). For example, wherein a wall thickness of a first unreinforced portion of the apparatus is essentially doubled by the area of the gusset added to the first portion.

When one or more welds are employed in the making of an integrally formed apparatus, and/or employed about some or all of a perimeter of an added gusset, preferably the welding comprises not less than a 0.35″ wire milled steel weld(s).

While a use of common inter-fittable and durable steel tube material, suitable for steel welds may be employed, alternatively or additionally one or more of the (or all) three portions of the apparatus may be made partially or entirely out of a minimized-weight durable material of at least equal strength, such as one or more of the following: a composite metal or alloy, a plastic or polymer material, a reinforced plastic or polymer material, a carbon fiber material, graphene, or a composite material including graphene, and the like.

The present invention further comprises preferred embodiments wherein a short riser may be included intermediate an upper surface of the aforementioned second, low-profile winch mounting central portion, and a lower surface of a winch mount, wherein preferably, outer opposite sides of the riser and at least a low-profile winch mounting central portion therebelow include a reinforcing gusset The riser may be made of a same, albeit shorter type of material as the second, low-profile winch mounting central portion below it, and may be cut at opposite ends so as to have a trapezoidal or rectangular side profile, wherein preferably each end is ‘capped’ having welded to it a rectangular portion that in-effect seals the end.

In such embodiments, the height of the short riser provides a reduced or minimized vertical moment arm winch mount, wherein the low-profile trailer hitch ball and a winch mounted atop the reduced or minimized moment arm winch mount are each configured simultaneously or separately employable. The reduced or minimized vertical moment arm mounted winch, providing a corresponding reduced or minimized winch mount height, allows for pull-forces applied to a generally horizontal outwardly extended cable portion of a mounted winch to be principally or closely aligned with a horizontal axis and with one or more mounting points and/or seams (or ‘mounting means’) at which a respective trailer hitch receiver, or a trailer hitch receiver-like apparatus to is secured to a respective vehicle and to which the apparatus is releasably fastened.

In a preferred embodiment of the present invention providing a minimized vertical moment arm of close to 2″ or less (i.e., “close” being +/−0.375″), a planar underside portion of a winch mount is integrally formed with, or welded to, an upper side portion of a normally horizontal elongate tube member preferably located on a forward-facing side adjacent or proximate to an upper end portion of a trailer hitch ball mount. Wherein the elongate tube member is preferably made of a sturdy and durable square or rectangular tube material (e.g., entirely or partially made of at least one of steel, an alloy, a composite, graphene).

A distal end of the horizontal elongate member is integrally formed with, or welded to, a normally rearward side of the trailer hitch ball mount, which in turn, is configured for a mounting of a releasably fastenable trailer hitch ball. An opposite end portion of the horizontal elongate member is configured for being inserted into and releasably fastened within a trailer hitch receiver tube, such that an outwardly-extending remainder portion of the elongate member, between the receiver tube opening and the trailer hitch ball mount, provides an intermediate elongate member winch support portion providing the aforementioned upper side portion having the winch mount. Wherein, a pull-force applied to an outwardly extended cable portion of a mounted winch has a vertical moment arm of about 2″ inches or less, relative to an upper surface of the horizontal elongate member.

In a preferred embodiment of the present invention providing a reduced vertical moment arm of close to 4″ or less (i.e., “close” being +/−0.375″), a planar underside portion of a winch mount is integrally formed with, or welded to, an upper side portion of a short, 2″ height or less, riser which in turn has an underside integrally formed with, or welded to, an upper side portion of a normally horizontally elongate tube member. Wherein the elongate tube member, the distal end portion thereof, the trailer hitch receiver end portion and a trailer hitch ball mount are each configured in substantially the same manner as previously described. The 2″ height short riser can preferably be made of a portion of square tube or rectangular tube such as the type used for the normally horizontally elongate tube member, and may further be shaped having a side profile which is trapezoidal wherein an upper side of the short riser is shorter in length than an underside thereof. Preferably each of a first vertical side and an opposite second vertical side of a short riser aligned above a respective first vertical side and an opposite second vertical side of an intermediate portion of an elongate tube member thereunder is integrally formed with, or welded to, a planar gusset generally matching the side profile of a respective upper riser vertical-side and preferably a somewhat wider portion of an intermediate portion thereunder. Wherein the elongate tube member and riser are preferably made of a sturdy and durable square or rectangular tube material comprising at least one of the aforementioned types of apparatus component material.

It also noted, that at such time when more advanced lighter and stronger materials are available such as graphene, or a combination of graphene and one or more other materials, either the aforementioned reduced, or the minimized, vertical moment arm embodiment can be made of such material(s) in which case, the described outer planar gussets, used for reinforcement with current readily available materials, can be eliminated. Further, such advanced material(s) may further limit the need to employ a tube shaped material and instead employ material having other than a hollow square or rectangle cross-section e.g., having a C, U or L shaped cross-section.

Preferably the height of a winch mount and winch mounted securely atop thereof are such that a minimized or reduced vertical moment arm is employed having sufficient height clearance when mounted on an aforementioned trailer hitch receiver, or recessed trailer hitch receiver, so as to be operatively employable for winch and/or trailer pulling purposes proximate, or under, a vehicle-end profile of various vehicle types, including those having a hinged hatch, tailgate, lift gate, one or more doors, or the like.

In operation, each of the minimized or reduced vertical moment arm embodiments provides an elongate horizontal member having an end configured to be removably secured within a trailer hitch receiver mounted on an end or end-underside of a vehicle-end of one of a diverse range of vehicles e.g., releasably mounted in a customary manner. Once an appropriate winch is securely mounted on a winch mount of the apparatus, the winch is positioned at a height advantageously employable for utilizing up to a maximum horizontal pull-force rated for a given trailer hitch receiver vehicle. For example, the apparatus of the present invention is adaptable to accommodate winches having a pull-force in the 8000 to 12,000 pounds' range, for varied tasks and purposes, so long as the trailer hitch receiver maximum rated pull-force is not exceeded.

The foregoing has outlined rather broadly the features and technical advantages of the present invention so that those skilled in the art may better understand the detailed description of the invention that follows. Additional features and advantages of the invention will be described hereinafter that will form the subject of the claims of the invention. Those skilled in the art should appreciate that they may readily use the conception and the specific embodiments disclosed as a basis for modifying or designing other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIGS. 1A-1E are a series of two-dimensional views each depicting a different side of a low-profile hitch ball mount and a low-profile winch mount of a reduced vertical moment arm embodiment of the trailer hitch and winch incorporating apparatus of the present invention. Wherein FIGS. 1A, 1B and 1E are each depicted having a winch mount mounted atop a short riser which in turn is mounted atop an upper side of an elongate tube member, wherein outer sides of the riser and outer sides of a wider portion thereunder (depicted in FIG. 1A) are reinforced by a planar gusset. Wherein FIG. 1A is a side view, FIG. 1B is a front view depicted aligned in height with FIG. 1A, FIG. 1C is a top view, FIG. 1D is a bottom view, and FIG. 1E is a rear view.

FIGS. 2A-2E are a series of two-dimensional views similar to FIGS. 1A-1E with each view depicting a different side of a low-profile hitch ball mount and a low-profile winch mount of a minimized vertical moment arm embodiment of the trailer hitch and winch incorporating apparatus of the present invention, having no riser, an instead having a winch mount mounted atop an upper side or a reduced-height upper side of an elongate tube member proximate to an upper end portion of a trailer hitch ball mount. Wherein FIG. 2A is a side view, FIG. 2B is a front view depicted aligned in height with FIG. 2A, FIG. 2C is a top view, FIG. 2D is a bottom view, and FIG. 2E is a rear view.

FIGS. 3A-3B are two three-dimensional figures of a multi-segmented/exteriorly-pinned “Prior Art” reference ‘Thompson Ser. No. 10/653,810’ namely: “FIG. 1” and “FIG. 2” (respectively). In FIG. 3A the Thompson apparatus is depicted having a “J” shaped profile. An upper dashed line represents a horizontal axis typical of an outwardly extended portion of a winch cable wherein a letter “A” and adjacent arrow indicate a winch cable pull-force axis, bracket 100 represents a vertical moment arm having a length relative to an axis of, and longer than, a mounted lower horizontal elongate member.

In FIG. 3B the Thompson apparatus is depicted having a “L” shaped profile, wherein the multi-segmented/pinned apparatus acts as a lever arm with “C” arrow pointing to a fulcrum point.

FIG. 4A and FIG. 4B are two side views of an integrally formed low-profile, hitch ball mount and a low-profile, winch mount apparatus, operable for towing and/or winching operations, wherein in FIG. 4A a short riser is located intermediate a lower side of low-profile winch mount and an upper side of a horizontal elongate member, and in FIG. 4B a low-profile winch mount is located adjacent an upper side of a horizontal elongate member, wherein in both embodiments an apparatus comprises a first, low-profile hitch ball mounting distal portion, a second, low-profile winch mounting central portion, and a third, trailer hitch receiver insertable portion, integrally formed end-to-end.

### DETAILED DESCRIPTION OF THE PREFERRED EMBODIMENTS

For improving clarity of understanding and a coherence of features depicted in two or more of the drawing figures one or more reference numerals employed in an earlier drawing figure may be repeated in one or more subsequent figures.

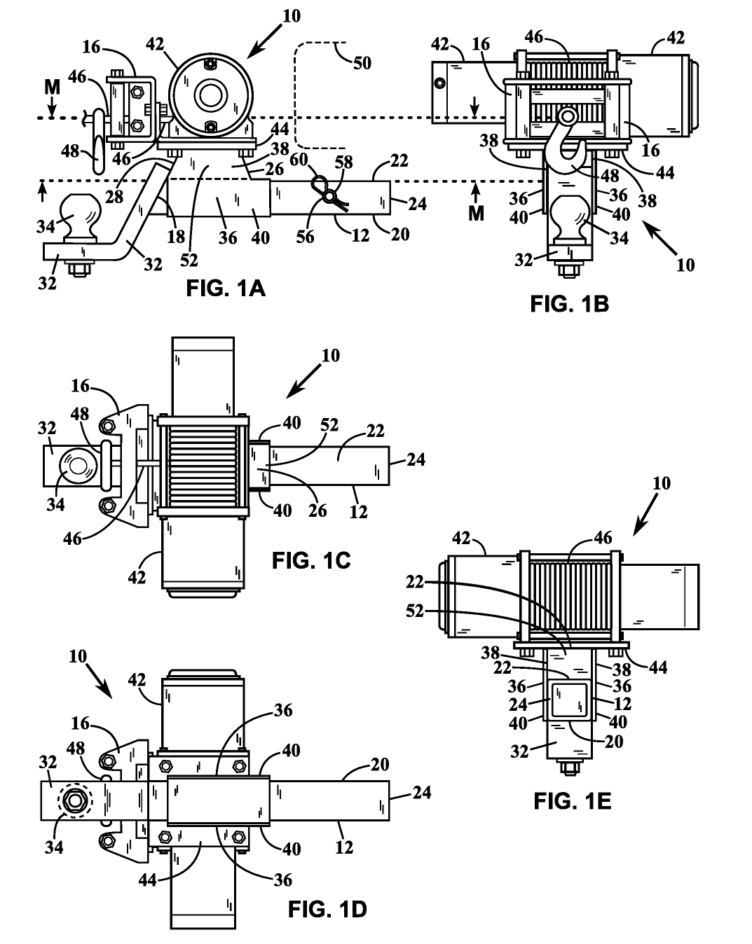

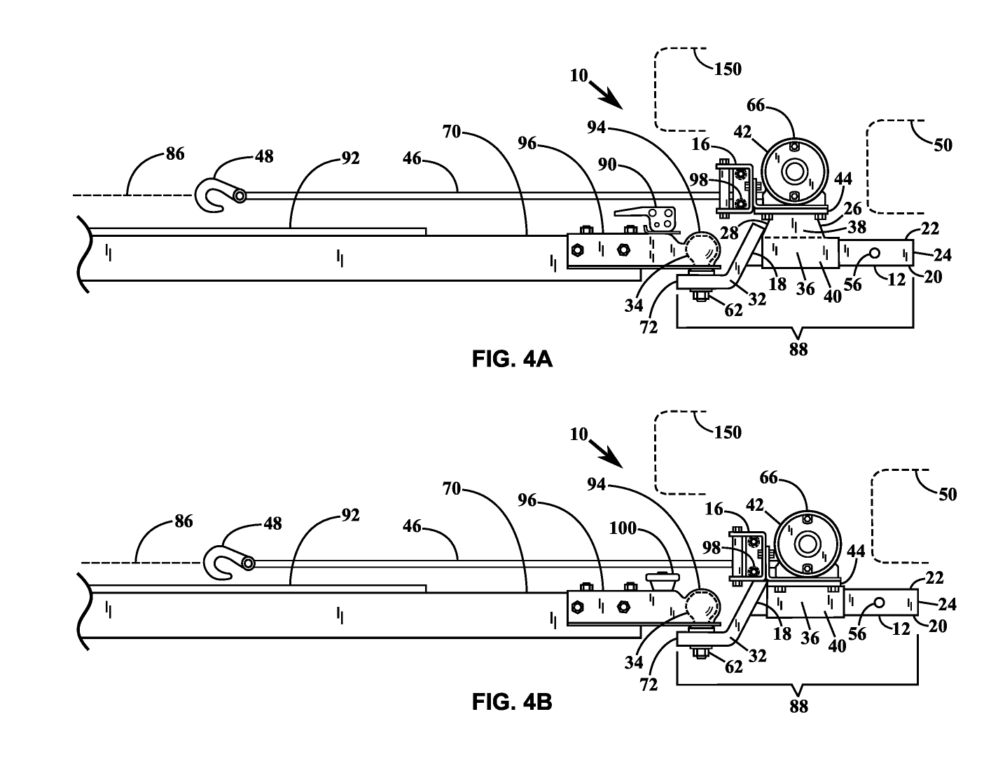

In reference to the side view of FIG. 1A and the front view of FIG. 1B aligned horizontally therewith, a low-profile hitch ball mount 32 and a low-profile winch mount 44 of a reduced vertical moment arm embodiment of the trailer hitch and winch incorporating apparatus of the present invention is depicted. As seen in FIGS. 1A and 1B, the low-profile aspect of the hitch ball mount 32 provides sufficient vertical spacing between an upper side of a mounted hitch ball 34 (e.g., lower than upper surface 22) and winch cable 46, such that when the latter is extended outwardly from a lower side of a drum of the winch 42, e.g., in alignment with a horizontal axis, the hook 48 and winch cable 46 are unimpeded by the mounted hitch ball. Accordingly, optimal tensionings or pull-forces can then be exerted on the winch cable in alignment with a horizontal axis, due to the winch cable 46 being unencumbered or unobstructed by the mounted ball, or a coupler secured onto the ball (e.g., see FIGS. 4A and 4B). To further optimize tensionings or pull-forces that can be exerted on a winch cable 46, the height of the winch cable when spooling on or off a lower portion of a drum of the winch is kept at or below a reduced vertical moment arm height/length, wherein the reduced vertical moment arm is represented having an “M” vertical moment length, of about 4″ or less, indicated between parallel dashed horizontal lines extending from FIG. 1A into FIG. 1B, wherein the lower dashed line is aligned with an upper side 22 of elongate horizontal tube member 12, and the higher dashed line is aligned with an axis of a winch pull-force when applied to a generally horizontal outwardly extended portion of a winch cable 46. In FIG. 1A winch cable 46 is shown extending outwardly from a lower portion of a winch drum (not shown) of winch 42 e.g., passing through a fairlead housing 16, such that, a winch pull-force applied to an outwardly extending portion of a winch cable 46 e.g., when engaging an object engaged by a hook 48 thereof, is transferred to a lower portion of the winch drum at a height or moment arm of about 4″ above the elongate tube member upper side 22. Preferably, the vertical moment height/cable pull-force axis is at, or about at, a height aligned with, or closely in alignment with, one or more seams and/or attachment points of a corresponding trailer hitch receiver mounted to vehicle such that a majority of a generally horizontal pull-force applied to the cable 46 is a horizontal pull-force applied to the mounted vehicle-mounted receiver and a simultaneous downward force thereto is reduced.

A “C” shaped dashed outline portion 50 is shown between FIG. 1A and FIG. 1B indicating a side profile portion or partial outline of a vehicle-end bumper e.g., at the front or rear of a vehicle, wherein, due to its low-height profile, the highest portion of winch 42, mounted atop a winch mount 44, which in turn is mounted atop short riser 52, is lower in height than an upper side of the bumper side profile 50, such that, in many cases, a hinged tailgate, lift gate, or one more doors operable above the bumper is/are not impeded or restricted by the mounted winch height. The side view of FIG. 1A further depicts a preferably trapezoidal shaped short riser 38 (a lower side of which is indicated by a horizontal dashed line). Preferably, for increased winch pull-force strength, one or both opposite vertical sides of an intermediate portion of the elongate horizontal tube member 12 and the riser 52 thereabove are each integrally formed with, or welded to, an inward-facing side of a reinforcing planar side gusset 36 wherein a gusset upper portion 38 and gusset lower portion 40 have a side profile generally matching that of the short riser 52 and intermediate portion of elongate tube member 12.

A distal end 18 of the elongate tube member 12 is preferably integrally formed with, or welded to, a trailer hitch ball mount 32 e.g., of a type configured for releasably fastening a trail hitch ball thereto. Preferably an upper end portion of the trailer hitch ball mount extends upwardly somewhat above the upper side 22 of the tube member 12 which serves as an additional stop reinforcing the mounting of short riser 52. An opposite end portion of tube member 12 proximate end 24 is configured for being inserted into a trailer hitch receiver tube (not shown) and releasably fastened within the receiver tube by suitable fastening means e.g., a lock-pin 56 insertable through a pair of transversely aligned apertures 58 of tube member 12 and of a corresponding receiver tube. Preferably fastening means include releasably fastenable fasteners e.g., a pin keeper 60 may be employed to releasably retain a lock-pin in place (or by one or more other types of fasteners or threaded fasteners).

In operation, FIGS. 1A through 1E illustrate how a winch hook 48 coupled to an end of a winch cable 46 is available to be extended generally horizontally outward from a lower side of a winch drum to be connected with an object to which a substantial winch pull-force may then be exerted, along an horizontal axis perpendicular to a vertical moment arm of “M” of about 4″ (or less e.g., proportional to a shorter height riser 52). Accordingly, depending on the maximum acceptable pull-force rating of a mounted winch type employed and that of a corresponding vehicle-mounted trailer hitch receiver, or other appropriate winch mounting means, an apparatus of the present invention can be configured to apply winch pull-forces in a range of up to an upper four-figures or low five-figures in pounds (e.g., up to 8,000 or 12,000 lbs.) independently or while simultaneously coupled to a trailer or a towed vehicle (such pull-force ranges also being a function of the limits of the type of trailer hitch receiver employed and the manner in which it is fastened, connected or otherwise adjoined with a respective vehicle). Whereby, a majority of a mounted winch (42) horizontal pull-force can be made aligned with, or within a 4″ or less close alignment with, one or more connecting points or seams of a mounted trailer hitch receiver apparatus joining, and/or integrally formed between, the receiver apparatus and one or more substantive portions of a vehicle e.g., one or more frame or chassis locations. Alternatively, an enhanced winch pull-force attributable to a majority of a mounted winch (42) horizontal pulling being made aligned with, or within a 4″ or less close alignment with, an axis which in turn is aligned with one or more connecting points or seams of a mounted trailer hitch receiver apparatus is also provided. For example, wherein a generally U-shaped pull-force path transfers a pull-force exerted at a first upper portion of the ‘U’ such as a winch cable of a mounted winch through a lower horizontal portion of the ‘U’ path such as through an elongate tube member 12 to a second upper portion of the ‘U’ path to one or more connecting points or seams of a mounted trailer hitch receiver apparatus aligned at a height similar to, or the same as, the height of the winch cable at the first upper portion of the ‘U’ shape.

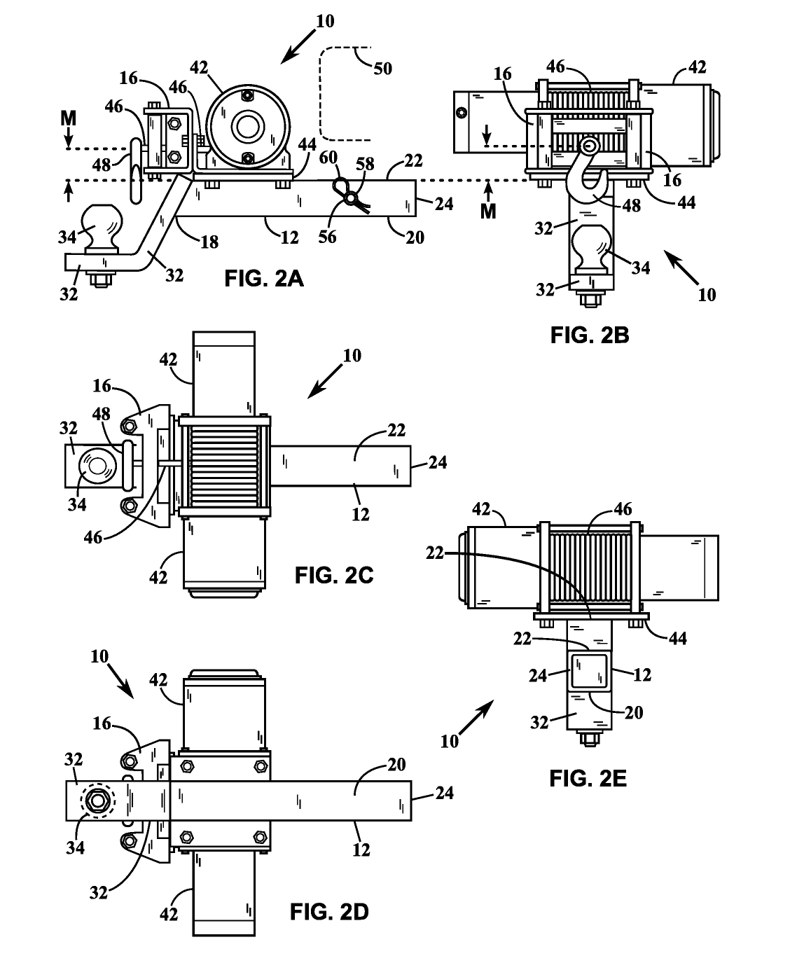

In reference to the side view of FIG. 2A and the front view of FIG. 2B aligned horizontally therewith, a low-profile hitch ball mount 32 and a low-profile winch mount 44 of a minimized vertical moment arm embodiment of the trailer hitch and winch incorporating apparatus of the present invention is depicted. As seen in FIGS. 2A and 2B, the low-profile aspect of the hitch ball mount 32 provides sufficient vertical spacing between an upper side of a mounted hitch ball 34 (e.g., lower than upper surface 22) and winch cable 46, such that when the latter is extended outwardly from a lower side of a drum of the winch 42, e.g., in alignment with a horizontal axis, the hook 48 and winch cable 46 are unimpeded by the mounted hitch ball. Accordingly, optimal tensionings or pull-forces can then be exerted on the winch cable in alignment with a horizontal axis, due to the winch cable 46 being unencumbered or unobstructed by the mounted ball, or a coupler secured onto the ball (e.g., see FIGS. 4A and 4B). To further optimize tensionings or pull-forces that can be exerted on a winch cable 46, the height of the winch cable when spooling on or off a lower portion of a drum of the winch is kept at or below a reduced vertical moment arm height/length, wherein the minimized vertical moment arm is represented having an “M” vertical moment length, of about 1.5″ to 2″ or less, indicated between parallel dashed horizontal lines extending from FIG. 2A into FIG. 2B, wherein the lower dashed line is aligned with an upper side 22 of elongate horizontal tube member 12, and the higher dashed line is aligned with an axis of a winch pull-force when applied to a generally horizontal outwardly extended portion of a winch cable 46.

It is noted that “M” vertical moment lengths indicated in FIGS. 1A-1B and 2A-2B are also determined by the diameter of a lower horizontal roller e.g., within a fairlead housing 16, and a mounting height of the winch mounting plate 44 relative to a horizontal elongate tube member 12 therebelow. So for example, in a preferred one of the embodiments depicted in FIGS. 1A-1B, a short riser 52 can be made with a decreased height and/or by the diameter of a lower roller in a fairlead housing being somewhat reduced, and in either case the vertical moment arm “M” will be correspondingly decreased.

Alternatively, with respect to a preferred one of the embodiments depicted in FIGS. 2A-2B, an intermediate portion of elongate tube member 12 and optionally an upper portion of trailer hitch ball mount 32 can be configured having a reduced height cutout portion 54 e.g., optionally also having one or more sides thereof reinforced with a gusset, such as a lower elongate gusset 64 (cutout 54 and lower gusset 64 are each shown as a dashed-line outline in FIG. 2A) for example wherein the intermediate portion and optionally the upper ball mount are reduced in height by a quarter or third, in which case the winch mount 44 can be lowered from the height of the elongate tube member upper side 22 shown in FIG. 2A to the height provided by a cutout portion 54, in which case, the vertical moment arm “M” will be correspondingly decreased. Alternatively, an upper portion of a ball mount 32 and fairlead housing 16 can be configured such that the ball mount upper portion extends somewhat upwardly and inwardly into a lower portion of the fairlead housing wherein an upper end thereof is near, but not in contact with, a lower side of a winch cable 46. In each case, a winch pull-force applied to an outwardly extending portion of a winch cable 46 e.g., when engaging an object engaged by a hook 48 thereof, is transferred to a lower portion of the winch drum at a minimized height or moment arm above the elongate tube member 12. Preferably, the vertical moment height/cable pull-force axis is at, or about at, a height aligned with, or closely in alignment with, one or more seams and/or attachment points of a corresponding trailer hitch receiver mounted to vehicle, such that a substantial majority of a generally horizontal pull-force applied to the cable 46 is applied to a vehicle-mounted receiver and a lesser or residual simultaneous downward force applied thereto is significantly reduced, which in turn, facilitates the combined trailer hitch ball and winch incorporating apparatus of the present invention in attaining higher to highest winch pull-forces such as those nearing or meeting a maximum safe and allowable rating for all of its respective apparatus-related components.

A generally “C” shaped dashed outline portion 50 is shown between FIG. 2A and FIG. 2B indicating a side profile portion or partial outline of a vehicle-end bumper, wherein, due to its low-height profile, the highest portion of winch 42, mounted atop a winch mount 44 is considerably lower in height than an upper side of the bumper side profile 50, such that, in many cases, a hinged tailgate, lift gate, or one more doors operable above the bumper is/are not impeded or restricted by the mounted winch height.

While foregoing descriptions pertaining to an employment of one or more reinforcing gussets have described gussets integrally formed with, or welded to, a corresponding component of the apparatus of the present invention it is not that additionally or alternatively one or more gussets can configured adjoining or fixed to an apparatus component by means of one or more other fastening means including, but not limited to, a series of rivets, bolts, machine screws, pins, or an adhesive, an epoxy, a sonic-welding, and the like.

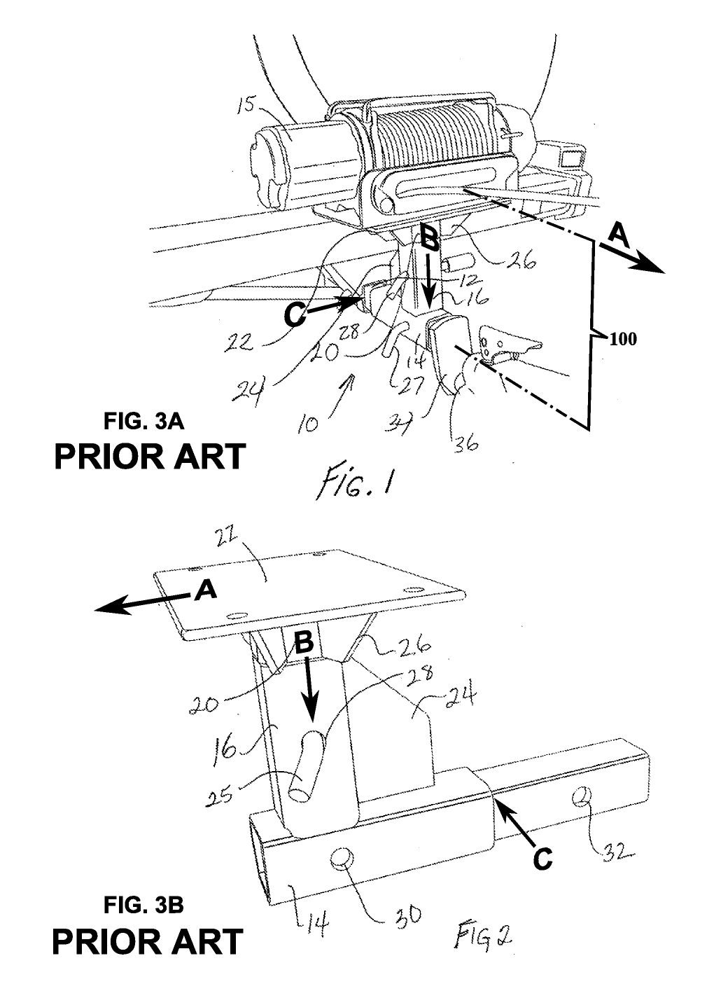

In reference to FIGS. 3A-3B, two hand-drawn three-dimensional figures of a “Prior Art” reference disclosing a multi-segmented/pinned apparatus of ‘Thompson Ser. No. 10/653,810’ are shown (which were also briefly described in the Background of the Invention section above), namely: Thompson '810 “FIG. 1” and “FIG. 2” (respectively). In FIG. 3A of the present application, the Thompson apparatus is depicted having a somewhat “J” shaped profile or orientation wherein, it can be seen that a combined ‘jointed’ height of a “vertical steel tube 16”, a vertically inserted winch mount (generally equivalent in height to vertical moment arm 100 in FIG. 3A), and a winch 15 mounted thereabove are mounted closely laterally spaced from a hinged member pivotally mounted on a vehicle-end (e.g., rear door(s), tailgate or lift gate of a typical vehicle). It can also be seen that the combined ‘jointed and pinned height’ of the Thompson components extends upward, well into a significant portion of a vehicle-end profile. Thus configured, the hinged vehicle member is substantially restricted in movement by the Thompson approach, if not essentially prohibited from movement, whether hinged for a horizontal or vertical pivoting, and whether the vertically-aligned components of the mounted winch apparatus are dormant, or when the winch 15 is being employed.

In contrast, it can be seen that if instead, the winch, winch mount and/or winch mount support height were lowered to a height as shown in FIGS. 1A, 1B and 1E, or as in FIGS. 2A, 2B and 2E of the present invention, a hinged member located at a vehicle-end of many vehicle types would be free to be movably pivoted in a fully typical manner. The same reduced or minimized height/moment arm approaches of the present invention would also be suitable for mounting on many of the aforementioned recessed trailer hitch receivers (wherein the winch itself in part, or entirely, is located under a vehicle-end profile.

Returning to FIG. 3A, an upper dashed line is provided which represents a horizontal axis typical of an outwardly extended portion of a winch cable wherein a letter “A” and adjacent arrow indicate a winch cable pull-force or force vector, bracket 100 represents a vertical moment arm having a length relative to an axis of, and longer than, a mounted lower horizontal member 14. FIG. 3A further shows, a type of “J” shaped lever which upon receiving a pull-force at “A” transfers a portion of force “A” downward as “B” via vertical member 16 which is depicted taller in length than corresponding horizontal member 14, such that the J-shaped lever exerts a substantially downward load at “C” serving as a type of fulcrum point (i.e., located adjacent the opening of a trailer receiver tube). Because the Thompson vertical member “B—up to the height of the winch cable—is a vertical moment arm having a length greater than the length of member 14 downward forces exerted at “C” will be substantially greater, than those exerted proximate a vehicle receiver tube opening by the substantially reduced or minimized moment arms “M” depicted in FIGS. 1A, 1B and 1E, or as in FIGS. 2A, 2B and 2E of the present invention.

For ease of reference, relating to the same “A”, “B” and “C” forces when exerted relative to a generally L-shaped profile or orientation, FIG. 3B of the Thompson apparatus (hand-drawn FIG. 2) is also provided, wherein the multi-segmented/pinned apparatus acts as an L-shaped lever arm with “C” arrow, pointing to a fulcrum point.

Accordingly, prior art such as the Thompson reference depicts an exteriorly multi-segmented and multi-pinned apparatus that either, applies substantially greater downward forces at a trailer hitch receiver tube opening transferred through its trailer hitch and winch incorporating apparatus, or potentially even increases such forces due to it incorporating and functioning in-effect as a taller-than-wide lever. In contrast, the present invention instead employs significantly reduced or minimized vertical moment arms upon which its winches are mounted, which substantially reduce or minimize such unneeded and/or potentially damaging downward forces exerted onto a trailer hitch receiver tube opening, a trailer hitch receiver itself and one or more connecting points and/or seams mounting the receiver to a vehicle-end.

In reference to the side views of FIG. 4A and FIG. 4B, preferred embodiments of a low-profile, hitch ball mount 32 and a low-profile, winch mount 44 apparatus, operable for towing and/or winching operations, are depicted, each comprising a first, low-profile hitch ball mounting distal portion, a second, low-profile winch mounting central portion, and a third, trailer hitch receiver insertable portion, wherein the three portions are integrally formed end-to-end, between apparatus distal end 72 and horizontal member receiver-insertion end 24 (above bracket 88). Accordingly, no portion of the apparatus exterior to an inserted and secured trailer hitch receiver insertable portion, is made segmented, jointed or pinnable, e.g., having a pair of transverse aligned apertures so as to be fastened together by an inserting of, or separable by a removal of, a respective keeper or pin.

As can also be seen in FIG. 4A and FIG. 4B, a winch cable 46, when extending outwardly in alignment with a horizontal axis 86, is employable during winching operations in a manner unimpeded and/or unobstructed by a proximate mounted hitch ball 34, or thereabove, a portion of a locking mechanism employed to pivotally couple a ball coupler 94 of a coupler housing 96 to the ball 34 e.g., a latch 90 depicted lowered in FIG. 4A, or a ball coupler screw handle 100 depicted in FIG. 4B.

The low-profile aspect of the hitch ball mount 32, preferably comprises, an upper surface of a horizontal portion of the mount, which is lower in height than that of horizontal member lower side 20, employable to support a lower end of a mounted hitch ball 34 such that sufficient vertical spacing is provided between an upper side of the hitch ball (e.g., at or lower than the height of upper surface 22) and a winch cable 46, whereby the cable may be extended outwardly from a lower side of a winch cable drum of a mounted winch 42, e.g., in alignment with a horizontal axis 86, in a manner unimpeded and/or unobstructed by a proximate mounted hitch ball 34, or by an upper portion of a locking mechanism (e.g., 90 or 100).

As can also be seen in FIGS. 4A and 4B, the cable 46 and hook 48 may be extended outwardly, tensioned and/or employed during winching operations in a horizontal axis (e.g., in a higher or highest pull-force manner) (i.) separately without a trailer being coupled to the apparatus, or (ii.) with a trailer being coupled, and the winch cable being employable closely parallel above a horizontal trailer frame 70 and/or flat trailer bed 92, and the like.

Accordingly, optimal tensionings or pull-forces can be exerted on a winch cable 46 when employed in alignment with a horizontal axis 86, due to one or more of the following: the winch cable being unencumbered or unobstructed by a proximate mounted hitch ball 34, or a locking mechanism of a coupler securing the coupler onto the ball; the low-height of the winch cable 46 extending outwardly from a lower side of a horizontal drum of a winch 42 when mounted atop a low-profile winch mount 44 allowing the tensionings or pull-forces to be aligned, or closely aligned, with a plurality of connecting or attachment points at which the trailer hitch receiver is mounted or secured to a respective vehicle; the height of the winch cable when spooling on or off a lower portion of a drum of the low profile mounted winch, being kept at or below a vertical moment arm height/length of about two inches or less.

FIGS. 4A and 4B further depict a low-profile, integrally formed hitch ball mount 32 and a low-profile, winch mount 44 apparatus, wherein a winch 42 is mounted on the apparatus such that an upper side surface 66 of the winch is lower than an upper generally horizontal surface of a vehicle bumper. Each dashed-line 50 and 150 in FIGS. 4A and 4B represents an upper, rear and lower cross-sectional contour or profile of an approximately located bumper, wherein a low-profile winch 42 is mountable behind a rearward-facing bumper 50, or in front of a frontward-facing bumper 50, while also having the height of a winch upper surface 66 below the bumper's upper surface. Alternatively, on vehicles having a high ground clearance and a trailer hitch receiver mounted under an end of the vehicle and spaced inwardly away from a bumper 150, a low-profile, integrally formed hitch ball mount 32 and winch mount 44 apparatus 10 can be releasably secured mostly or entirely under the vehicle end, and perform one or more towing and/or winching operations in a similar or identical manner as those performed by the aforementioned winch 42 mounted behind a rearward-facing bumper 50, or in front of a frontward-facing bumper 50.

Accordingly, a number of towing and/or winching operations may be accomplished by the integrally formed apparatus 10 wherein, during one or more of such, one or more doors or hinged members pivotally mounted proximate a rear end of the vehicle may be opened or closed above a bumper 50 or 150 e.g., over a full pivot range, without being impeded or obstructed by the winch 42 (or upper side surface 66 thereof). Similarly, several towing and/or winching operations may be accomplished by the integrally formed apparatus 10 wherein, during one or more of such, a hinged tailgate may be lowered or raised above a bumper 50 or 150 e.g., over a full pivot range, without being impeded or obstructed by the winch 42 (or upper side surface 66 thereof).

Although the present invention and its advantages have been described in detail, those skilled in the art should understand that they can make various changes, substitutions and alterations herein without departing from the spirit and scope of the invention in its broadest form.

I claim:

1. An integrally formed apparatus selectively operable for winching and/or towing operations mountable to and removable from a vehicle end-mounted trailer hitch receiver, comprising:
an angled low-profile hitch ball mount of the integrally formed apparatus, having a lower, normally distal horizontal portion on which a trailer hitch ball is removably fastenable;
an elongate horizontal portion of the integrally formed apparatus, intermediate the angled hitch ball mount and a hitch receiver insertable portion of the apparatus, having adjoined with an upper side portion, a low-profile winch mount on which a winch is removably fastenable;
the low-profile hitch ball mount and the low-profile winch mount adjoined with the integrally formed apparatus such that a vertically-spaced interval is provided between the two mounts;
the vertically-spaced interval located in height such that the height of an upper surface of a fastened trailer hitch ball is at or lower than the upper side of said elongate horizontal portion, such that the fastened hitch ball does not impede, interfere with or obstruct a tensioning or pull-force exerted on a winch cable, of a winch fastened to the low-profile winch mount, when the cable is extending outwardly principally in alignment with a horizontal axis, or in a close parallel alignment with a bed of a trailer coupled to the fastened hitch ball.

2. The integrally formed apparatus of claim 1, comprising:
a vertically-spaced interval provided between the two mounts and located in height such that the height of a coupler locking mechanism located adjacent an upper side of a coupler housing employed to couple a ball coupler onto the fastened hitch ball, does not impede, interfere with or obstruct a tensioning or pull-force exerted on a winch cable, of a winch fastened to the low-profile winch mount, when the cable is extending outwardly principally in alignment with a horizontal axis, or in a close parallel alignment with a bed of a trailer coupled to the fastened hitch ball.

3. The integrally formed apparatus of claim 1, comprising:
forming one or more portions of the integrally formed apparatus out of a durable lightweight material comprising at least one of a composite metal or alloy, a plastic or polymer material, a reinforced plastic or polymer material, a carbon fiber material, graphene, or a composite material including graphene.

4. The integrally formed apparatus of claim 1, further comprising:
positively mounted on the low-profile winch mount a winch of a high pull-force range operable during either or both of:
one or more winching operations during which the low-profile hitch ball is not employed;
one or more winching operations during which the low-profile hitch ball is concurrently employed.

5. The integrally formed apparatus of claim 1 further comprising:
at least one integrally formed apparatus operatively installed on at least one of two respective trailer hitch receivers of a same vehicle, wherein,
the at least one apparatus is operatively installed for use proximate or under a rear portion of the vehicle, and/or,
operatively installed for use proximate or under a front portion of the vehicle.

6. The integrally formed apparatus of claim 1 comprising:
the low-profile hitch ball mount and the low-profile winch mount adjoined with the integrally formed apparatus,
a vertically-spaced interval provided between the two mounts and located in height such that a winch mounted on a low-profile winch mount does not impede or obstruct a full-range of movement of a pivotally mounted one or more doors, a hatch, a lift-gate, a tailgate.

7. The integrally formed apparatus of claim 1 further comprising:
each of one or more sides of at least a central portion of the integrally formed apparatus having a respective gusset welded to an apparatus side about one or more perimeter portions of a given gusset, or the respective gusset adjoined to or with an apparatus side.

8. The integrally formed apparatus of claim 1 further comprising:
a low vertical moment arm riser, adjoined intermediate a generally central portion of the integrally formed apparatus and an underside portion of the low-profile winch mount, so as to increase a vertically-spaced interval between the two mounts; wherein,
the riser is made of a same material as the elongate horizontal member of the integrally formed apparatus, has a trapezoidal or rectangular side profile shape, and is about two inches or less in height.

9. The integrally formed apparatus of claim 1, comprising:
a first, low-profile hitch ball mounting distal portion, a second, low-profile winch mounting central portion, and a third, trailer hitch receiver insertable portion, wherein the three portions are integrally formed end-to-end, between an apparatus distal end and horizontal member receiver-insertion end; wherein,
neither the first, low-profile hitch ball mounting distal portion, nor the second, low-profile winch mounting central portion of the integrally formed apparatus, exterior to an inserted and secured trailer hitch receiver insertable portion, is made segmented, jointed or separable from another portion; and,
only the trailer hitch receiver insertable portion and a respective trailer hitch receiver have transverse aligned apertures so as to be fastened together by an inserting of, or separable by a removal of, a respective keeper, fastener or pin.

10. The integrally formed apparatus of claim 1, further comprising:
the winch mounted on a low-profile winch mount of the integrally formed apparatus such that the lowest height of an operatively engaged winch cable extending outwardly from a lower side of a winch drum, in a generally horizontal manner, is higher than that of an upper side of a trailer tongue pivotally coupled to a trailer hitch ball, or a coupler locking mechanism atop the trailer tongue.

11. The integrally formed apparatus of claim 10, further comprising:
the winch mounted on the low-profile winch mount of the integrally formed apparatus such that the height of mounted winch does not impede, interfere with or obstruct a full-range of movement, or a nearly full-range of movement of a pivotally mounted one or more doors, a hatch, a lift-gate, a tailgate.

12. The integrally formed apparatus of claim 1, further comprising:
a welding employed on or about one or more of the portions and/or gusset(s) of the apparatus, consisting of not less than about a 0.35″ wire milled steel weld.

13. A method of providing an unobstructed horizontal tensioning of a cable, of a low-profile mounted winch, extended closely parallel over at least a portion of a bed of a trailer coupled to a hitch ball of a low-profile hitch ball mount of an integrally formed apparatus supporting the mounted winch, comprising:
providing a low-profile, hitch ball mount at a normally distal horizontal portion of the integrally formed apparatus, which supports a hitch ball fastened on the low-profile hitch ball mount;
providing, adjacently above an elongate horizontal member of the integrally formed apparatus intermediate the distal horizontal portion and a hitch receiver insertable portion of the apparatus, a low-profile winch mount which supports a winch fastened on the low-profile winch mount; and,
providing, in an adjoining of the low-profile hitch ball mount and the low-profile winch mount with the integrally formed apparatus, a vertically-spaced interval between the two mounts, such that a winch cable of the mounted winch extending outwardly principally and closely parallel above the bed of the trailer, during a winching operation, is unimpeded or unobstructed by the low-profile mounted hitch ball, or by a coupler locking mechanism securing a ball coupler of a coupler housing of the trailer to the low-profile hitch ball.

14. The method of claim 13 comprising:
forming one or more portions of the integrally formed apparatus out of a durable lightweight material comprising at least one of a composite metal or alloy, a plastic or polymer material, a reinforced plastic or polymer material, a carbon fiber material, graphene, or a composite material including graphene.

15. The method of claim 13 wherein the coupler locking mechanism is higher than the height of the low-profile mounted hitch ball and comprises one of a latch, a screw handle;
providing a vertically-spaced interval between said two mounts such that the winch cable extending outwardly principally and closely parallel with the bed of the trailer, during a winching operation, is unimpeded or unobstructed by the latch or screw handle.

16. The method of claim 13 further comprising:
mounting a winch of a high pull-force range securely on the low-profile winch mount and employing the winch in either or both of one or more winching operations during which the low-profile hitch ball is not employed, one or more winching operations during which the low-profile hitch ball is concurrently employed.

17. The method of claim 13 further comprising:
installing at least one integrally formed apparatus on at least one of two respective trailer hitch receivers on a same vehicle, such that the at least one apparatus is operatively installed for use proximate or under a rear portion of the vehicle, and/or operatively installed for use proximate or under a front portion of the vehicle.

18. The method of claim 13 further comprising:
adjoining the low-profile hitch ball mount and the low-profile winch mount with the integrally formed apparatus, wherein a vertically-spaced interval between the two mounts is provided, such that, a winch mounted on the low-profile winch mount does not impede or obstruct a full-range of movement of a pivotally mounted one or more doors, a hatch, a lift-gate, a tailgate.

19. The method of claim 13 further comprising:
providing a low vertical moment arm riser, adjoined intermediate a generally central portion of the integrally formed apparatus and an underside portion of the low-profile winch mount, so as to increase a vertically-spaced interval between the two mounts; wherein,
the riser is made of a same material as the elongate horizontal member of the integrally formed apparatus, has a trapezoidal or rectangular side profile shape, and is about two inches or less in height.

20. The method of claim 13 further comprising:
reinforcing each of one or more sides of at least a central portion of the integrally formed apparatus with a respective gusset welded, to an apparatus side, about one or more perimeter portions of a given gusset, or the respective gusset adjoined to or with an apparatus side.
